(19) United States
(12) Patent Application Publication
(10) Pub. No.: US 2016/0032810 A1
(43) Pub. Date: Feb. 4, 2016

(54) MIXER FOR EXHAUST GAS AFTERTREATMENT SYSTEM

(71) Applicant: Caterpillar Inc., Peoria, IL (US)

(72) Inventors: Andrew M. Denis, Peoria, IL (US); Timur Trubnikov, Peoria, IL (US); Umakanth Sakaray, Peoria, IL (US); Kevin J. Weiss, Peoria, IL (US); Chiranjeevi Mangamuri, Peoria, IL (US); Nagaraju Manchikanti, Peoria, IL (US)

(73) Assignee: Caterpillar Inc., Peoria, IL (US)

(21) Appl. No.: 14/884,796

(22) Filed: Oct. 16, 2015

(51) Int. Cl. F01N 3/28; B01F 3/04; B01F 5/06; F01N 3/20

(52) U.S. Cl. CPC F01N 3/2892; F01N 3/2066; B01F 3/04007; B01F 5/0602

(57) ABSTRACT

An exhaust gas aftertreatment system includes an exhaust conduit having an inner wall, and a mixer mounted inside the exhaust conduit. The exhaust conduit defines a passage along a length of the exhaust conduit for exhaust gas flow therethrough. The mixer includes first bars coupled to second bars. Each first bar includes deflectors on a straight section, a first end, and a second end. The one or more of the first bars include a curved section at the first end and the second end. Each second bar includes a straight section, a third end, and a fourth end. The one or more of the second bars include a curved section at the third end and the fourth end. The mixer is mounted inside the exhaust conduit by coupling the curved section of the first bar and the second bar to the inner wall of the exhaust conduit.

### TECHNICAL FIELD

The present disclosure relates to exhaust gas aftertreatment systems, and more specifically, to a mixer arrangement for use in an exhaust gas aftertreatment system.

### BACKGROUND

An exhaust gas aftertreatment system is used to reduce various harmful gases present in exhaust gases such as Carbon Monoxide (CO), and different oxides of nitrogen such as Nitric Oxide (NO), Nitrogen Dioxide (NO₂) etc. The exhaust gas aftertreatment system converts such harmful gases into harmless gases such as Nitrogen (N₂) and Hydrogen (H₂) etc. Typically, in an exhaust gas aftertreatment system, urea is injected into the stream of the exhaust gases. The mixture of the exhaust gases and the urea is then exposed to SCR catalyst, where the exhaust gases and the urea react to convert harmful gases into harmless gases. In order for complete reduction of the harmful gases, a uniform distribution of urea in the exhaust gases is desired after injection.

To achieve a uniform distribution of urea into the exhaust gases, a mixer is placed in the flow path of the exhaust gases, downstream of the point of injection of urea in the exhaust gases. Various kind of mixers are currently known, that are used in exhaust gas aftertreatment systems. These mixers include a number of bars having deflectors that disrupt the flow of exhaust gases aiding in uniform mixing of urea in exhaust gases. As the mixers are placed in flow path of the exhaust gases, they are exposed to high temperature and high vibration conditions during operation of the exhaust gas aftertreatment system, which results in buckling of the mixers. This in turn leads to poor performance of the exhaust gas aftertreatment system due to non-uniform mixing of urea into the exhaust gases. Moreover, frequent replacement of the mixer in the exhaust gas aftertreatment systems leads to unnecessary downtime of the engine. Therefore, an improved exhaust gas aftertreatment system is desired which is able to work in high temperature and high vibration conditions.

US Patent Publication Number 20100074814 discloses a mixer for use in the exhaust gas aftertreatment system. The mixer includes multiple mixer bars and crossbars, each mixer bar includes blades extending from the mixer bars. The mixer bars and the crossbars are arranged perpendicular to each other. The mixer further includes an outer ring connected to each end of the mixer bars and the crossbars, which makes the mixer construction rigid. Therefore, at high temperatures, thermal expansion in the mixer bars and crossbars may result buckling of the mixer bars, crossbars and the outer ring. A more robust mixer is desired that can aid in uniform mixing of urea and, can withstand high temperature and high vibration conditions without buckling

### SUMMARY OF THE DISCLOSURE

In one aspect of the present disclosure, an exhaust gas aftertreatment system is provided. The exhaust gas aftertreatment system includes an exhaust conduit configured to define a passage along a length of the exhaust conduit for exhaust gas flow therethrough. The exhaust conduit having at least one inner wall. A mixer mounted in the exhaust conduit in a direction perpendicular to the length of the exhaust conduit. The mixer includes a plurality of first bars. Each first bar includes a plurality of deflectors on a straight section, a first end, and a second end. The at least one first bar of the plurality of first bars includes a curved section at at least one of the first end and the second end. The mixer includes a plurality of second bars. Each second bar includes a straight section, a third end, and a fourth end. The at least one second bar of the plurality of second bars includes a curved section at at least one of the third end and the fourth end. The at least one of the plurality of first bars is coupled to the at least one of the plurality of second bars. The mixer is mounted inside the exhaust conduit by coupling the curved section of the at least one first bar and the curved section of the at least one second bar to the at least one inner wall of the exhaust conduit.

Other features and aspects of this disclosure will be apparent from the following description and the accompanying drawings.

### BRIEF DESCRIPTION OF THE DRAWINGS

FIG. 1 is a perspective view of an exemplary exhaust gas aftertreatment system, in accordance with the concepts of the present disclosure;

FIG. 2 is a front view of a mixer having first bars and second bars along with detailed view of a first bar and a second bar, in accordance with the concepts of the present disclosure;

FIG. 3 is a side view of the mixer, in accordance with the concepts of the present disclosure;

FIG. 4 is a front view of the mixer mounted on an exhaust conduit of the exhaust gas aftertreatment system, in accordance with the concepts of the present disclosure; and

FIG. 5 shows a front view of a second embodiment of a mixer, in accordance with the concepts of the present disclosure.

### DETAILED DESCRIPTION

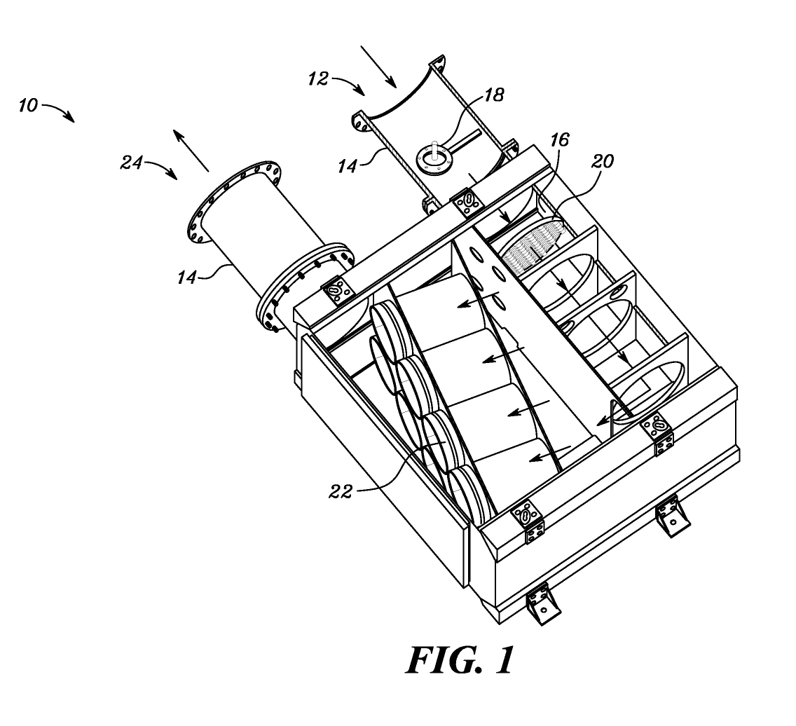

FIG. 1 is a perspective view of an exemplary exhaust gas aftertreatment system 10, in accordance with the concepts of the present disclosure. The exhaust gas aftertreatment system 10 includes an inlet 12, an exhaust conduit 14 having an inner wall 16, an injector nozzle 18, a mixer 20, a selective catalytic reduction module 22, and an outlet 24. The exhaust gas aftertreatment system 10 is used in high power engines such as marine engines, power generators etc. It should be noted that the exhaust gas aftertreatment system 10 may be used in machines such as, but not limited to, hydraulic excavator, track type tractor etc. The exhaust gas aftertreatment system 10 further includes various other components such as, but not limited to, a sensor control box, an electrical connector, and so on. For the purpose of simplicity, the various other components of the exhaust gas aftertreatment system 10 are not labeled in FIG. 1.

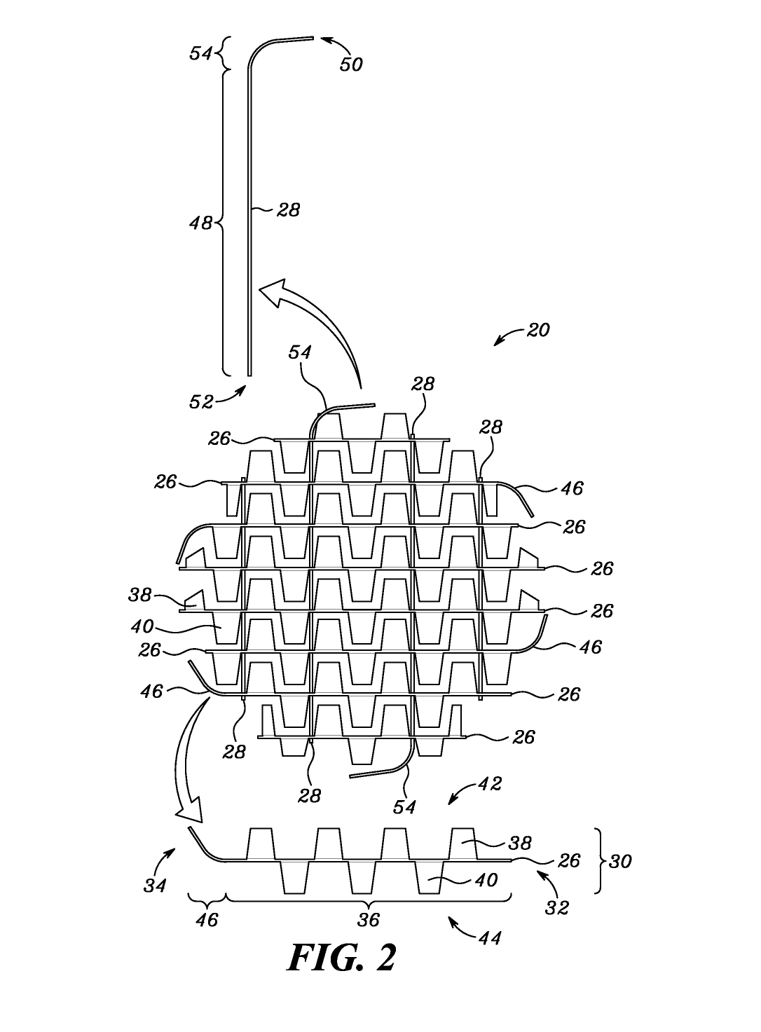

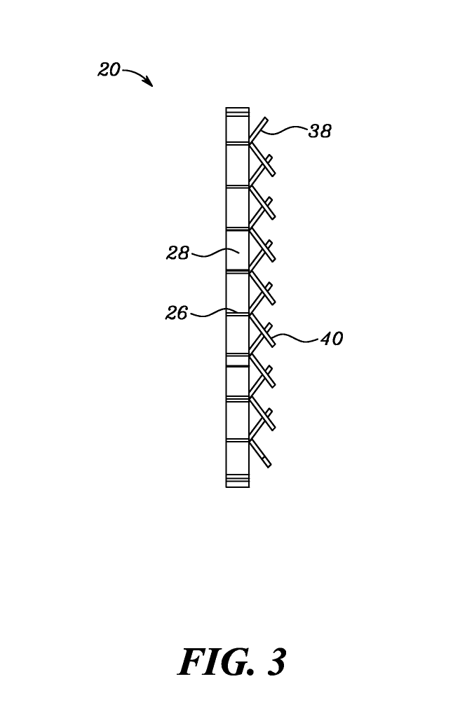

The exhaust gas aftertreatment system 10 is utilized to reduce harmful gases present in exhaust gases such as, but not limited to, Carbon Monoxide (CO), and different oxides of nitrogen such as Nitric Oxide (NO), Nitrogen Dioxide (NO₂), unburned hydrocarbons etc. The exhaust gases enter the exhaust gas aftertreatment system 10 through the inlet 12, and then flow through the exhaust conduit 14 which is configured to define a passage along a length of the exhaust conduit 14 for the exhaust gases. The exhaust gases are further mixed with an aqueous solution of urea, which is injected through the injector nozzle 18. After the injection of urea, the exhaust gases mixed with urea are passed through the mixer 20 which is mounted inside the exhaust conduit 14 in a direction perpendicular to the length of the exhaust conduit 14. The mixer 20 uniformly mixes the aqueous solution of the urea into the exhaust gases. The exhaust gases mixed with the urea are then passed through the selective catalytic reduction module 22, where the water from the aqueous solution of the urea and the exhaust gases is evaporated due to high temperature and releases the ammonia. The ammonia then reacts with the exhaust gases such as nitric oxide (NO) or the nitrogen dioxide (NO₂), and the water, and thus converts the harmful nitric oxide (NO) or the nitrogen dioxide (NO₂), and the ammonia (NH₃) into harmless gas particles of nitrogen and water. Thereafter, the exhaust gases are expelled from the exhaust gas aftertreatment system 10 through the outlet 24. The detailed description of the mixer 20 is described later in conjunction with FIGS. 2 and 3.

FIGS. 2 and 3 show a front view and a side view of the mixer 20, in accordance with the concepts of the present disclosure. The mixer 20 includes a number of first bars 26 coupled to a number of second bars 28. The first bars 26 and the second bars 28 are arranged perpendicular to each other. Each one of the first bars 26 having a number of deflectors 30 (i.e., a number of flaps), a first end 32, and a second end 34. The deflectors 30 are arranged along the length of a straight section 36 of each one of the first bars 26. Referring specifically to FIG. 3, the deflectors 30 include a first set of deflectors 38 and a second set of deflectors 40 located at opposite sides of a plane passing through the straight section 36 of each one of the first bars 26. More specifically, the first set of deflectors 38 bend towards a first surface 42 of the straight section 36, and the second set of deflectors 40 bend towards a second surface 44 (opposite to the first surface 42) of the straight section 36. The first set of deflectors 38 and the second set of deflectors 40, are designed to disrupt the flow of the exhaust gases mixed with the urea, and thus result in the uniform distribution of the aqueous solution of the urea into the exhaust gases. The deflectors 30 may be of various shapes such as, but not limited to, trapezoidal shape, conical shape, semi-circular shape etc. Further, one or more first bars 26 include a curved section 46 either at the first end 32, or at the second end 34, or at both ends (i.e., the first end 32, and the second end 34) of the one or more first bars 26. FIG. 2 shows the mixer 20 including the first bars 26 having the curved section 46 at only one of the first end 32 and the second end 34. However, in an alternate embodiment, the curved section 46 may be provided at each of the first end 32 and the second end 34. Also, some of the first bars 26 in FIG. 2 do not include the curved section 46 at either the first end 32 or the second end 34. In an alternate embodiment, each one of the first bars 26 may include the curved section 46 at one or both of the first end 32 and the second end 34.

On the other hand, each one of the second bars 28 includes a straight section 48, a third end 50, and a fourth end 52. Further, one or more second bars 28 include a curved section 54 either at the third end 50, or at the fourth end 52, or at both ends (i.e., the third end 50, and the fourth end 52) of the one or more second bars 28. As shown in FIG. 2, the curved section 54 corresponds to a bent portion present either at the third end 50, or at the fourth end 52 of the one or more second bars 28. FIG. 2 shows the mixer 20 including the second bars 28 having the curved section 54 at only one of the third end 50 and the fourth end 50. However, in an alternate embodiment, the curved section 54 may be provided at each of the third end 50 and the fourth end 52. Also, some of the second bars 28 in FIG, 2 do not include the curved section 54 at either the third end 50, or at the fourth end 52. In an alternate embodiment, each of the second bars 28 may include the curved section 54 at one or both of the third end 50 and the fourth end 52.

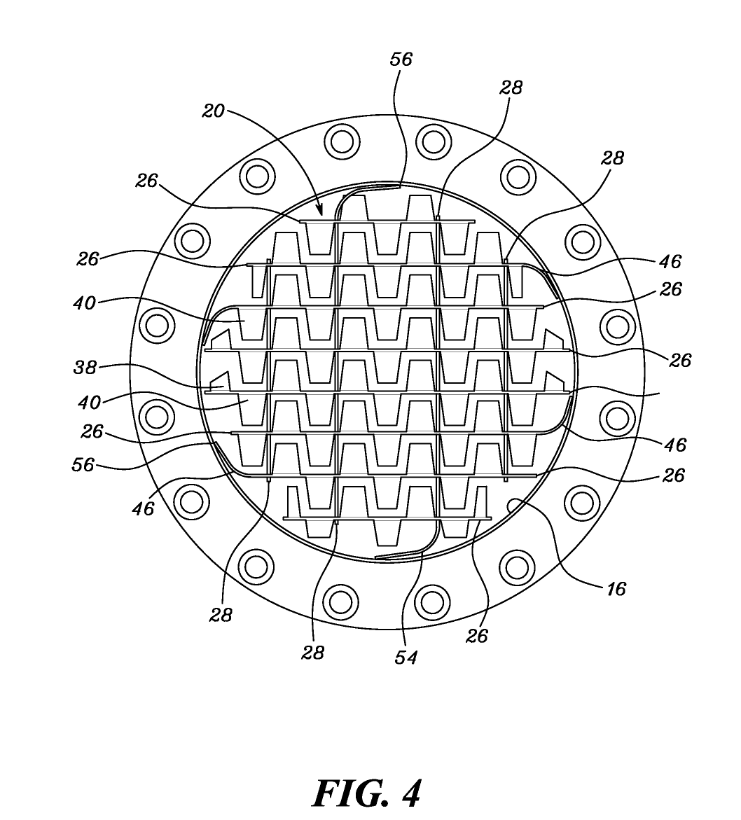

FIG. 4 shows a front view of the mixer 20 mounted on the exhaust conduit 14 of the exhaust gas aftertreatment system 10, in accordance with the concepts of the present disclosure. As shown in FIG. 4, the mixer 20 is mounted inside the exhaust conduit 14 by coupling the curved section 46 of the one or more first bars 26 and the curved section 54 of the one or more second bars 28 to the inner wall 16 of the exhaust conduit 14 through a fillet weld 56. The fillet weld 56 joins the curved section 46 of the one or more first bars 26 and the curved section 54 of the one or more second bars 28 to the inner wall 16 of the exhaust conduit 14 in order to provide a leaf-spring like flexibility to the mixer 20.

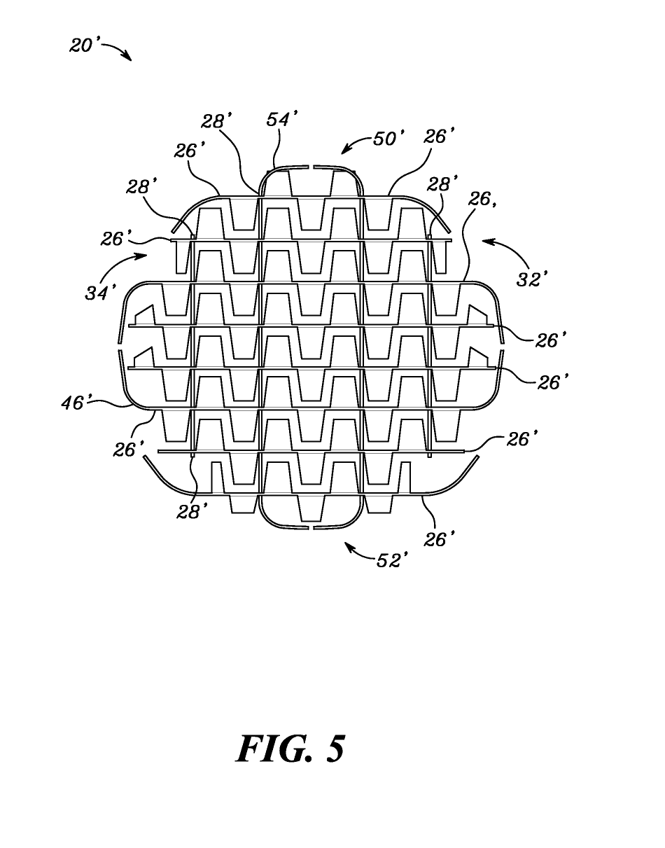

FIG. 5 is a front view of a second embodiment of a mixer 20′, in accordance with the concepts of the present disclosure. The mixer 20′ includes a curved section 46′at both the ends (i.e., a first end 32′ and a second end 34′) of one or more first bars 26′, and a curved section 54′ at both the ends (i.e., a third end 50′ and a fourth end 52′) of one or more second bars 28′. The mixer 20′ includes twelve curved sections (i.e., the curved section 46′, and the curved section 54′), that allow more number of the fillet weld 56 between the exhaust conduit 14 and the mixer 20′. It will be apparent to one skilled in the art that the number of curved sections (i.e., the curved section 46′, and the curved section 54′) may be less than twelve, or more than twelve, without departing from the scope of the disclosure.

Further, in an embodiment, the mixer 20 is made up of materials such as, but not limited to, steel, stainless steel, chromium-steel alloys, or nickel-steel alloys. It should be noted that the mixer 20 may be made up of some other materials as well, without departing from the scope of the disclosure. Further, the number of curved sections (i.e., the curved section 46, and the curved section 54) in the mixer 20 is selected depending upon various parameters such as, but not limited to, a diameter of the exhaust conduit 14, a number of the first bars 26, a number of the second bars 28, a material of construction of the first bars 26 and the second bars 28, speed of the exhaust gases passing through the exhaust conduit 14.

### INDUSTRIAL APPLICABILITY

An exhaust gas aftertreatment system is used to convert various harmful gases present in exhaust gases into harmless gases. In order to convert the harmful gases into the harmless gases, a uniform distribution of urea in the exhaust gases is desired. To achieve a uniform distribution of urea into the exhaust gases, a mixer is placed in the flow path of the exhaust gases. Currently, known mixers include a number of bars having deflectors that disrupt the flow of exhaust gases aiding in uniform mixing of the urea in the exhaust gases. As the mixers are placed in the flow path of the exhaust gases, they are exposed to high temperature and high vibration conditions during operation of the exhaust gas aftertreatment system, which results in buckling of the mixers. This in turn leads to poor performance of the exhaust gas aftertreatment system due to non-uniform mixing of urea into exhaust gases. Therefore, an improved exhaust gas aftertreatment system is desired which is able to work in high temperature and high vibration conditions.

The present disclosure provides the exhaust gas aftertreatment system 10. The exhaust gas aftertreatment system 10 discloses the mixer 20 which includes the first bars 26 having the deflectors 30. The deflectors 30 disrupt the flow of the exhaust gases, and thus result in the uniform distribution of the aqueous solution of the urea into the exhaust gases. Further, the mixer 20 is mounted inside the exhaust conduit 14 by coupling the curved section 46 of the one or more first bars 26 and the curved section 54 of the one or more second bars 28 to the inner wall 16 of the exhaust conduit 14 through the fillet weld 56 in order to provide a leaf-spring like flexibility to the mixer 20. Such flexibility in the structure of the mixer 20 enables the mixer 20 to withstand high temperature and high vibration conditions during the operation of the exhaust gas aftertreatment system 10. Thus, such type of the mixer 20 for the exhaust gas aftertreatment system 10 prevents thermal buckling of the first bars 26 and the second bars 28, and provides improved stability and fatigue strength to the mixer 20, and thereby eliminating the downtime of the engine due to a failure of the mixer 20.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An exhaust gas aftertreatment system comprising:
an exhaust conduit configured to define a passage along a length of the exhaust conduit for exhaust gas flow therethrough, the exhaust conduit having at least one inner wall; and
a mixer mounted in the exhaust conduit in a direction perpendicular to the length of the exhaust conduit, the mixer including:
a plurality of first bars, each first bar including a plurality of deflectors on a straight section, a first end, and a second end, wherein at least one first bar of the plurality of first bars includes a curved section at at least one of the first end and the second end; and
a plurality of second bars, each second bar including a straight section, a third end, and a fourth end, wherein at least one second bar of the plurality of second bars includes a curved section at at least one of the third end and the fourth end;
wherein at least one of the plurality of first bars is coupled to at least one of the plurality of second bars;
wherein the mixer is mounted inside the exhaust conduit by coupling the curved section of the at least one first bar and the curved section of the at least one second bar to the at least one inner wall of the exhaust conduit.
